(19) United States
(12) Patent Application Publication
(10) Pub. No.: US 2001/0031706 A1
(43) Pub. Date: Oct. 18, 2001

(54) LUBRICANT FILM

(76) Inventors: TAKAAKI UCHIDA, ICHIHARA-SHI (JP); TAIZOU SUGIOKA, ICHIHARA-SHI (JP); KEISUKE FUNAKI, ICHIHARA-SHI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/357,390

(22) Filed: Jul. 20, 1999

(30) Foreign Application Priority Data
Jul. 24, 1998 (JP) 10-209053

(51) Int. Cl. F16C 1/00

(52) U.S. Cl. 508/100

(57) ABSTRACT

Provided is a lubricant film having the advantages of high-temperature lubricity, environmental adaptation and workability. At least the surface layer of the film is of a styrenic polymer essentially having a syndiotactic structure or of a resin composition that comprises such a styrenic polymer essentially having a syndiotactic structure, and the layer has a degree of crystallinity of at least 30%, a film impact of at least 2000 J/m and a wettability index of at most 36. The film is favorable to process films.

### BACKGROUND OF THE INVENTION

1. Field of the Invention

The present invention relates to a lubricant film, more precisely, to a lubricant film of which at least the surface layer is of a styrenic polymer essentially having a syndiotactic structure (hereinafter referred to as “syndiotactic polystyrene” or “SPS”) or of a resin composition that comprises the polymer, and which has specific properties.

2. Description of the Related Art

A lubricant film is a generic term for “peelable” films, and typically includes release films, process films, wrapping films, etc. The release films are those to be applied to pressure-sensitive adhesive-coated paper, tapes and the like for the purpose of protecting the adhesive-coated area of those objects, for which they are stuck on the adhesive-coated surfaces of the objects. Before the objects are worked, the release films are removed therefrom. For example, the release films are applied to adhesive tapes, double-coated tapes, masking tapes, labels, seals, stickers, etc. They are also applied to chemical-coated poultices of nonwoven fabric or the like to cover and protect the chemical. The process films are used in producing substrates for printed circuit boards, ceramic parts for electronic appliances, thermosetting resin products, decorative laminated sheets and the like, for which they are sandwiched between metal plates or between resin plates so as to prevent the plates from adhering to each other while they are molded or worked. The wrapping films are used, for example, in wrapping caramels and the like so as to prevent the wrapped caramels from adhering to them.

As such lubricant films, especially as process films, known are conventional fluorine-containing films of Teflon (PTFE) or the like, poly(4-methylpentene-1) films, biaxially-oriented polyethylene terephthalate (PET) films coated with a silicone material, etc.

However, the fluorine-containing films are expensive and are difficult to incinerate. After use, the films are industrial wastes. Even when incinerated, they give off fluorine-containing dioxins. The poly(4-methylpentene-1) films have poor heat resistance and are problematic in that, when used in producing printed circuit board substrates, they often adhere to stainless steel sheets under heat. The biaxially-oriented polyethylene terephthalate films themselves have a high wettability index, and their releasability is not satisfactory. PET films coated with a silicone material are expensive, and are problematic in that the silicone material adheres to printed circuit board substrates, ceramic parts for electronic appliances, thermoplastic resin products, decorative laminated sheets and others.

### SUMMARY OF THE INVENTION

The present invention has been made in consideration of the viewpoints noted above, and its object is to provide a lubricant film having the advantages of high-temperature lubricity, environmental adaptation and workability.

We, the present inventors have assiduously studied and, as a result, have found that a specific lubricant film of which at least the surface layer is of a styrenic polymer essentially having a syndiotactic structure or of a resin composition comprising the above polymer has the advantages of high-temperature lubricity, environmental adaptation and workability. On the basis of these findings, we have completed the present invention.

Specifically, the invention provides a lubricant film as follows:

(1) A lubricant film of which at least the surface layer is of a styrenic polymer essentially having a syndiotactic structure or of a resin composition that comprises a styrenic polymer essentially having a syndiotactic structure, wherein the layer has a degree of crystallinity of at least 30%, a film impact of at least 2000 J/m and a wettability index of at most 36.

(2) The lubricant film of (1), wherein the resin composition that comprises a styrenic polymer essentially having a syndiotactic structure comprises from 50% up to but not including 100% by weight of a styrenic polymer essentially having a syndiotactic structure and from 0 to 50% by weight (but excluding 0% by weight) of a rubber-like elastomer.

(3) The lubricant film of (1) or (2), which is for process films.

(4) The lubricant film of (3), which is used in producing laminate sheets, in producing flexible printed circuit board substrates, in producing high-tech composite materials, or in producing sports and leisure goods.

### BRIEF DESCRIPTION OF THE DRAWING

FIG. 1 is a graphical cross-sectional view of a sample film constitution as sandwiched between a stainless steel sheet and a copper-plated resin sheet for testing the sample film for high-temperature peelability.

### DETAILED DESCRIPTION OF THE INVENTION

Preferred embodiments of the invention are described in detail hereinunder.

The lubricant film of the invention is characterized in that at least its surface layer is of a styrenic polymer essentially having a syndiotactic structure, which is described below, or of a resin composition that comprises such a styrenic polymer essentially having a syndiotactic structure.

1. Styrenic polymer essentially having a syndiotactic structure:

The styrenic polymer for use in the invention essentially has a syndiotactic structure, in which the syndiotactic structure indicates the stereo-structure of the polymer of such that the side chains of phenyl groups are alternately positioned in the opposite sides relative to the main chain composed of carbon-carbon bonds, and its tacticity is determined according to the nuclear magnetic resonance of the polymer with an isotopic carbon (¹³C-NMR). The tacticity to be determined according to ¹³C-NMR indicates the proportion of a plurality of continuous constitutional units in a polymer. For example, a polymer comprising two continuous constitutional units is referred to as a diad; that comprising three continuous constitutional units is referred to as a triad; and that comprising five continuous constitutional units is referred to as a pentad. The styrenic polymer essentially having a syndiotactic structure as referred to herein generally has a racemic diad syndiotacticity of 75% or higher, preferably 85% or higher, or has a racemic pentad syndiotacticity of 30% or higher, preferably 50% or higher, including, for example, polystyrene, poly(alkylstyrenes), poly(arylstyrenes), poly(halogenostyrenes), poly(halogenoalkylstyrenes), poly(alkoxystyrenes), poly(vinyl of benzoate), hydrogenated derivatives of those polymers, their mixtures, and copolymers consisting essentially of those polymers. The poly(alkylstyrenes) include, for example, poly(methylstyrene), poly(ethylstyrene), poly(isopropylstyrene), poly(tert-butylstyrene), etc. The poly(arylstyrenes) include, for example, poly(phenylstyrene), poly(vinylnaphthalene), poly(vinylstyrene), etc. The poly (halogenostyrenes) include, for example, poly(chlorostyrene), poly(bromostyrene), poly(fluorostyrene), etc. The poly(halogenoalkylstyrenes) include, for example, poly(chloromethylstyrene), etc. The poly(alkoxystyrenes) include, for example, poly(methoxystyrene), poly(ethoxystyrene), etc.

Of those styrenic polymers, especially preferred are polystyrene, poly(p-methylstyrene), poly(m-methylstyrene), poly(p-tert-butylstyrene), poly(p-chlorostyrene), poly(m-chlorostyrene), poly(p-fluorostyrene), hydrogenated polystyrene, and copolymers comprising those constitutional units.

The styrenic polymer essentially having a syndiotactic structure of that type can be produced, for example, by polymerizing styrenic monomers (corresponding to the intended styrenic polymer as above) in an inert hydrocarbon solvent or in the absence of a solvent, using a catalyst that comprises a titanium compound and a condensate of a trialkylaluminium compound with water (see JP-A 62-187708). Poly(halogenoalkylstyrenes) may be produced according to the method described in JP-A 1-46912; and hydrogenated polymers may be produced according to the method described in JP-A 1-178505.

2. Resin composition comprising syndiotactic polystyrene:

In the lubricant film of the invention, at least the surface layer may be of a syndiotactic polystyrene or may also be of a resin composition comprising a syndiotactic polystyrene. The resin composition comprises a syndiotactic polystyrene and a rubber-like elastomer. In this, the rubber-like elastomer is not specifically defined, and may be selected from those that are mentioned hereinunder.

In addition, the composition may optionally contain any thermoplastic resin except syndiotactic polystyrenes, and any additive of, for example, antiblocking agents, antioxidants, nucleating agents, antistatic agents, process oils, plasticizers, lubricants, flame retardants, flame retardation promoters, pigments, etc.

For incorporating these components into the composition, for example, employable is (i) a method of adding them in any stage in the production of syndiotactic polystyrene, followed by blending, melting and kneading them; (ii) a method of blending, melting and kneading the components that constitute the composition; or (iii) a method of blending them dry just before the composition is formed into films, and kneading them in the extruder as the composition is formed into films.

(1) Rubber-like elastomer:

The rubber-like elastomer for use in the invention includes, for example, natural rubber, polybutadiene, polyisoprene, polyisobutylene, neoprene, polysulfide rubber, Thiokol rubber, acrylic rubber, urethane rubber, silicone rubber, epichlorohydrin rubber, styrene-butadiene block copolymer (SBR), hydrogenated styrene-butadiene block copolymer (SEB), styrene-butadiene-styrene block copolymer (SBS), hydrogenated styrene-butadiene-styrene block copolymer (SEBS), styrene-isoprene block copolymer (SIR), hydrogenated styrene-isoprene block copolymer (SEP), styrene-isoprene-styrene block copolymer (SIS), hydrogenated styrene-isoprene-styrene block copolymer (SEPS), ethylene-propylene rubber (EPM), ethylene-propylene-diene rubber (EPDM); olefinic rubbers such as linear, low-density polyethylenic elastomers, etc.; core/shell type, granular elastomers, such as butadiene-acrylonitrile-styrene core/shell rubber (ABS), methyl methacrylate-butadiene-styrene core/shell rubber (MBS), methyl methacrylate-butyl acrylate-styrene core/shell rubber (MAS), octyl acrylate-butadiene-styrene core/shell rubber (MABS), alkyl acrylate-butadiene-acrylonitrile-styrene core/shell rubber (AABS), butadiene-styrene core/shell rubber (SBR), siloxane-containing core/shell rubber of typically methyl methacrylate-butyl acrylate siloxanes, etc.; and denatured rubbers to be prepared by denaturing those rubber materials.

Of those, especially preferred are SBR, SEB, SBS, SEBS, SIR, SEP, SIS, SEPS, core/shell rubbers, EPMS, EPDM, linear, low-density polyethylenic elastomers, and denatured rubbers from them.

Regarding the proportion of the rubber-like elastomer to be in the resin composition, for example, the composition may comprise from 50% up to buy not including 100% by weight, preferably from 50% to 98% by weight, more preferably from 60 to 98% by weight of the syndiotactic polystyrene and from greater than 0% to 50% by weight, preferably from 2% to 50% by weight, more preferably from 2% to 40% by weight of a rubber-like elastomer.

(2) Thermoplastic resin except syndiotactic polystyrene:

Any known thermoplastic resins except syndiotactic polystyrene are usable herein. Concretely mentioned are polyolefinic resins such as linear, high-density polyethylene, linear, low-density polyethylene, high-pressure-process, low-density polyethylene, isotactic polypropylene, syndiotactic polypropylene, block polypropylene, random polypropylene, polybutene, 1,2-polybutadiene, 4-methylpentene, cyclic polyolefins and their copolymers; polystyrenic resins such as atactic polystyrene, isotactic polystyrene, HIPS, ABS, AS, styrene-methacrylic acid copolymers, styrene-alkyl methacrylate copolymers, styrene-glycidyl methacrylate copolymers, styrene-acrylic acid copolymers, styrene-alkyl acrylate copolymers, styrene-maleic acid copolymers, styrene-fumaric acid copolymers, etc.; polyester resins such as polycarbonates, polyethylene terephthalate, polybutylene terephthalate, etc.; polyamide resins such as polyamide 6, polyamide 6,6, etc.; and polyphenylene ethers, PPS, etc. One or more of those thermoplastic resins can be used herein either singly or as combined.

The proportion of the thermoplastic resin except syndiotactic polystyrene that may be in the resin composition is not specifically defined, and may be suitably determined depending on the object of the composition.

(3) Other additives:

Various additives such as those mentioned below may be in the resin composition so far as they do not interfere with the object of the invention. Their amounts to be in the composition are not specifically defined, and may be suitably determined depending on the object of the composition.

(i) Anti-blocking agent (AB agent):

The anti-blocking agent for use in the invention includes, for example, inorganic grains and organic grains such as those mentioned below.

The inorganic grains are of oxides, hydroxides, sulfides, nitrides, halides, carbonates, sulfates, acetates, phosphates, phosphites, organic carboxylates, silicates, titanates and borates of elements of the Groups IA, IIA, IVA, VIA, VIIA, VIII, IB, IIB, IIIB, and IVB, and their hydrates and composites, as well as grains of natural minerals.

Concretely mentioned are grains of IA Group element compounds such as lithium fluoride, borax (sodium borate hydrate), etc.; Group IIA element compounds such as magnesium carbonate, magnesium phosphate, magnesium oxide (magnesia), magnesium chloride, magnesium acetate, magnesium fluoride, magnesium titanate, magnesium silicate, magnesium silicate hydrate (talc), calcium carbonate, calcium phosphate, calcium phosphite, calcium sulfate (gypsum), calcium acetate, calcium terephthalate, calcium hydroxide, calcium silicate, calcium fluoride, calcium titanate, strontium titanate, barium carbonate, barium phosphate, barium sulfate, barium sulfite, etc.; Group IVA element compounds such as titanium dioxide (titania), titanium monoxide, titanium nitride, zirconium dioxide (zirconia), zirconium monoxide, etc.; VIA Group element compounds such as molybdenum dioxide, molybdenum trioxide, molybdenum sulfide, etc.; VIIA Group element compounds such as manganese chloride, manganese acetate, etc.; Group VIII element compounds such as cobalt chloride, cobalt acetate, etc.; IB Group element compounds such as cuprous iodide, etc.; IIB Group element compounds such as zinc oxide, zinc acetate, etc.; IIIB Group element compounds such as aluminium oxide (alumina), aluminium hydroxide, aluminium fluoride, aluminosilicates (alumina silicate, kaolin, kaolinite), etc.; IVB Group element compounds such as silicon oxide (silica, silica gel), graphite, carbon, glass, etc.; as well as grains of other natural minerals such as carnallite, kainite, mica (including phlogopite), etc.

The organic grains are of Teflon, melamine resins, styrene-divinylbenzene copolymers, acrylic resin silicones and their crosslinked products.

The inorganic grains for use herein preferably have a mean grain size of from 0.1 to 10 μm, and their amount to be in the composition preferably falls between 0.01 and 15% by weight.

One or more of those inorganic fillers may be used herein either singly or combined.

(ii) Antioxidant:

Any known antioxidant is usable herein, including, for example, phosphorus-based, phenol-based, and sulfur-based antioxidants. One or more of those antioxidants may be used either singly or as combined. As the antioxidant, also preferred is 2-[1-hydroxy-3,5-di-t-pentylphenyl)ethyl]-4,6-di-t-pentylphenyl acrylate.

(iii) Nucleating agent:

The nucleating agent for use in the invention may be any conventional one, including, for example, metal carboxylates such as aluminium di (p-t-butylbenzoate), metal phosphates such as sodium methylene-bis (2,4-di-t-butylphenol) acid phosphate, and talc, phthalocyanine derivatives, etc. One or more of those nucleating agents may be used either singly or combined.

(iv) Plasticizer:

The plasticizer may be any conventional one, including, for example, polyethylene glycol, polyamide oligomer, ethylene-bis-stearamide, phthalates, polystyrene oligomer, polyethylene wax, silicone oil, etc. one or more of those plasticizers may be used either singly or combined.

(v) Lubricant:

The lubricant may be any conventional one, including, for example, polyethylene wax, silicone oil, long-chain carboxylic acids, and salts of long-chain carboxylic acids. One or more of those lubricants may be used either singly or combined.

(vi) Process oil:

The resin composition of the invention preferably contains a process oil having a dynamic viscosity at 40° C. of from 15 to 600 centistokes (cs) in order to increase its elongation.

The process oil typically includes paraffinic oils, naphthenic oils and aromatic oils. Of those, preferred are paraffinic oils where the percentage of carbon atoms constituting the paraffinic structure (linear chain), as calculated according to the n-d-M method, is at least 60% Cp of total carbons.

The process oil preferably has a dynamic viscosity at 40° C. of from 15 to 600 cs, more preferably from 15 to 500 cs.

A process oil having a dynamic viscosity of smaller than 15 cs could exhibit the effect of increasing the elongation of resins, but its boiling point is low. Therefore, when it is mixed with SPS in melt or when the resulting composition is molded, it gives white smoke, or yellows the moldings, or adheres to mold rolls. On the other hand, a process oil having a dynamic viscosity of larger than 600 cs will not give white smoke or will not yellow moldings, but its effect of increasing the elongation of resins will be poor.

The amount of the process oil to be in the resin composition preferably falls between 0.01 and 1.5 parts by weight, more preferably between 0.05 and 1.4 parts by weight, even more preferably between 0.1 and 1.3 parts by weight, relative to 100 parts by weight of the total of resin components, namely the total of SPS, the rubber-like elastomer and the thermoplastic resin except SPS.

If the amount of the process oil is smaller than 0.01 parts by weight, its effect of increasing the elongation of resins could not be expected; but if larger than 1.5 parts by weight, white smoking or yellowing will be difficult to retard even though the oil has a high viscosity. One or more those process oils may be used either singly or as combined.

3. Embodiments of the lubricant film of the invention:

The lubricant film of the invention must be such that at least its surface layer is of a styrenic polymer essentially having a syndiotactic structure or of a resin composition that comprises such a styrenic polymer essentially having a syndiotactic structure.

Concretely, the film may be a single-layered film of a syndiotactic polystyrene resin, or may be a multi-layered laminate film that comprises a surface layer of a syndiotactic polystyrene resin and other resin layers. In the multi-layered laminate film, at least its surface layer shall be of a syndiotactic polystyrene resin but the other resin layers may be of any desired resins.

In the single-layered film of a syndiotactic polystyrene resin and in the multi-layered laminate film that comprises a surface layer of a syndiotactic polystyrene resin and other resin layers, it is desirable that the thickness of the syndiotactic polystyrene resin layer is at least 5 μm, more preferably at least 10 μm. If the thickness of the SPS resin layer is smaller than 5 μm, the high-temperature lubricity of the film will be poor.

4. Physical properties of the lubricant film of the invention:

The lubricant film of the invention must have the following physical properties.

Specifically, in the lubricant film, it is necessary that the syndiotactic polystyrene resin moiety constituting its surface layer, such as that concretely mentioned hereinabove, has a degree of crystallinity of at least 30%, but preferably 35% or more, a film impact of at least 2000 J/m, but preferably 3000 J/m or more, and a wettability index of at most 36, but preferably at most 35.

If the degree of crystallinity is smaller than 30%, the high-temperature lubricity of the film will be poor. If the film impact is smaller than 2000 J/m, the film will be cracked when used, and will be difficult to handle. If the wettability index is larger than 36, the lubricity of the film after cooling will be poor.

5. Method for producing the lubricant film of the invention:

The method for producing the lubricant film of the invention is not specifically defined. For example, the film may be produced through casting, inflation molding, biaxial-orientation molding or the like. After having been produced in that manner, the film may be optionally subjected to heat treatment so as to have an intended degree of crystallization.

6. Applications of the lubricant film of the invention:

As so mentioned hereinabove, a lubricant film is a generic term for “peelable” films, and typically includes release films, process films, wrapping films, etc. The lubricant film of the invention includes all those types of peelable films. Concretely, the release films are applied, for example, to adhesive tapes, double-coated tapes, masking tapes, labels, seals, stickers, etc. They are also applied to chemical-coated poultices of nonwoven fabric or the like to cover and protect the chemical. The process films are used, as so mentioned hereinabove, in producing substrates for printed circuit boards, ceramic parts for electronic appliances, thermosetting resin products, decorative laminated sheets and the like, for which they are sandwiched between metal plates or between resin plates so as to prevent the plates from adhering to each other while they are molded or worked. In particular, they are favorably used in producing laminate sheets, in producing flexible printed circuit board substrates, in producing high-tech composite materials, or in producing sports and leisure goods. Concretely, where the lubricant film of the invention is used as a process film in a press-molding method for producing laminate sheets such as multi-layered substrates for printed circuit boards, it is sandwiched between a substrate being produced or having been produced and a separator plate or between two substrates so as to prevent their adhesion. The lubricant film of the invention is used also as a process film in producing substrates for flexible printed circuit boards such as those to be mounted on the mobile parts in electric and electronic appliances. For example, in a method of producing them, a cover resin is applied under heat and pressure onto a base film having thereon electric circuits as formed through etching or the like, so as to protect the electric circuits on the base film with it. In this step of the method, the lubricant film of the invention, serving as a process film, is used to wrap the cover resin, thereby ensuring airtight adhesion of the cover resin to the circuit pattern. The lubricant film of the invention is used also as a process film in producing high-tech composite materials. For example, it is used in producing various products by curing prepregs of glass cloth, carbon fiber or aramide fiber with epoxy resin. The lubricant film of the invention is used also as a process film in producing sports and leisure goods, such as fishing rods, golf clubs or shafts, wind surfing poles and the like. For example, a prepreg of glass cloth, carbon fiber or aramide fiber with epoxy resin is wound into a cylindrical rod for those goods, a tape of the lubricant film of the invention is wound around it, and the rod is cured in an autoclave.

Various applications of the lubricant film of the invention are mentioned above, which, however, are not limitative.

The invention is described in more detail with reference to the following Examples and Comparative Examples, which, however, are not intended to restrict the scope of the invention.

The physical properties of the film samples produced were measured and evaluated according to the methods mentioned below.

(1) Degree of crystallinity:

Using a differential scanning calorimeter, a sample film was heated at a heating rate of 20° C./min, and its melting enthalpy (ΔHf) and cold crystallization enthalpy (ΔH_{TCC}) were measured. From the data, the degree of crystallinity of the sample film was obtained according to the following equation:

Degree of Crystallinity (%)=100×(ΔHf−ΔH_{TCC})53 (J/g)

(2) Film impact:

A film impact tester (pendulum-type, from Toyo Seiki Seisaku-sho) was used, for which the impact head was 1 inch long.

(3) Wettability index:

Measured according to JIS K6768, for which used was a wettability index standard liquid (from Wako Pure Chemical Industries).

(4) High-temperature lubricity:

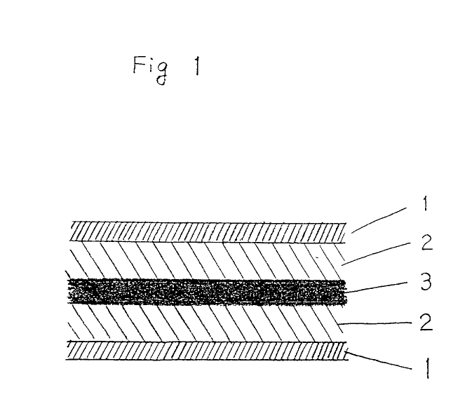

A sample film was set as in FIG. 1, where 1 indicates a stainless steel sheet (as buffed to have a surface roughness of at most 1 μm), 2 indicates the sample film, and 3 indicates a copper-plated resin sheet, and pressed under a pressure of 40 kg/cm² at 180° C. for 150 minutes. After this was left cooled at room temperature, the peeling strength between the film and the stainless steel sheet and that between the film and the copper-plated resin sheet were measured. The outward appearance of the peeled film was checked.

Starting materials used in producing the film samples are mentioned below.

SPS1:

Syndiotactic polystyrene, Xarec from Idemitsu Petrochemical,

Tm=270° C., MI=3 (300° C., 1.2 kgf)

SPS2:

Syndiotactic polystyrene, Xarec from Idemitsu Petrochemical,

Tm=270° C., MI=6 (300° C., 1.2 kgf)

SEBS:

SEBS-type elastomer, Septon 8006 from Kuraray.

SEPS:

SEPS-type elastomer, Septon 2104 from Kuraray.

PE1:

Low-density polyethylenic elastomer, ENGAGE 8150 from DuPont Dow Elastomer.

PE2:

High-pressure-process low-density polyethylene, Novatec LH100N from Nippon Polychem.

Nucleating agent:

Talc FFR from Asada Milling.

AB agent:

Antiblocking agent, aluminosilicate AMT-08 from Mizusawa Chemical.

HIPS:

High-Impact polystylene, HT52 from Idemitsu Petrochemical,

### EXAMPLE 1

74.8% by weight of SPS1 (syndiotactic polystyrene, Xarec from Idemitsu Petrochemical; Tm=270° C., MI=3 (300° C., 1.2 kgf)), 25% by weight of SEBS (SEBS-type elastomer, Septon 8006 from Kuraray) and 0.2% by weight of nucleating agent 1 (Talc FFR from Asada Milling) were blended dry, along with antioxidants, Irganox 1010 (from Ciba-Geigy), PEP36 (from Asahi Denka Kogyo) and Sumilizer GS (from Sumitomo Chemical) of being 0.1 parts by weight to SPS1 each. The resulting mixture was kneaded in melt and pelletized through a 65 mmφ double-screw extruder.

The resulting pellets were extruded in melt at 300° C. through a 50 mmφ single-screw (full-flight type screw) extruder equipped with a 500 mm-wide coat hanger die to give a film having a thickness of 25 μm, for which the extrusion rate was 20 kg/hr.

Using a tenter, the film was subjected to continuous heat treatment at 200° C. for 30 seconds. The data of the film obtained herein are in Table 1 below.

TABLE 1

| Composition | | | | | | |
|---|---|---|---|---|---|---|
| Component 1 | Component 2 | Component 3 | Component 4 | Component 5 | Molding | Layer |

| Example | Type | wt. % | Type | wt. % | Type | wt. % | Type | wt. % | Type | wt. % | Method | Constitution |
|---|---|---|---|---|---|---|---|---|---|---|---|---|
| Ex. 1 | SPS1 | 74.8 | SEBS | 25 | nucleating | 0.2 | — | — | — | — | casting | single layer |
| | | | | | agent | | | | | | | |
| Ex. 2 | SPS2 | 80 | PE1 | 16 | SEPS | 4 | — | — | — | — | casting | single layer |
| Ex. 3 | SPS1 | 80 | PE1 | 12 | SEPS | 4 | SEBS | 4 | — | — | casting | single layer |
| Ex. 4 | SPS1 | 80 | PE1 | 12 | SEPS | 4 | SEBS | 4 | — | — | casting | SPS/TPX |
| | | | | | | | | | | | (coextrusion) | |
| Ex. 5 | SPS1 | 80 | PE1 | 12 | SEPS | 4 | SEBS | 4 | — | — | casting | SPS/PP |
| Ex. 6 | SPS1 | 54.5 | PE2 | 24 | SEPS | 6 | HIPS | 15 | nucleating | 0.5 | inflation | single layer |
| | | | | | | | | | agent 1 | | | |
| Ex. 7 | SPS1 | 74.8 | SEBS | 25 | nucleating | 02 | — | — | — | — | inflation | single layer |
| | | | | | agent | | | | | | | |
| Ex. 8 | SPS2 | 99.9 | AB agent | 0.1 | — | — | — | — | — | — | biaxial | single layer |
| | | | | | | | | | | | orientation | |
| | | | | | | | | | | | molding | |
| Comp. Ex. 1 | polymethylpentene film [X-66] | | | | | | | | | | | |
| Comp. Ex. 2 | SPS1 | 74.8 | SEBS | 25 | nucleating | 0.2 | — | — | — | — | casting | single layer |
| | | | | | agent | | | | | | | |
| Comp. Ex. 3 | SPS2 | 99.9 | AB agent | 0.1 | — | — | — | — | — | — | casting | single layer |
| Comp. Ex. 4 | SPS1 | 74.8 | SEBS | 25 | nucleating | 0.2 | — | — | — | — | casting | single layer |
| | | | | | agent | | | | | | | |

| | | | | | Peelability from SUS sheet | | Peelability from Cu-plated sheet | |
|---|---|---|---|---|---|---|---|---|
| | | SPS Layer | | | (180° C., 40 kg, 150 min) | | (180° C., 40 kg, 150 min) | |
| | | Degree of | Film Impact | Wettability | Peeling Strength | Outward | Peeling Strength | Outward |
| Example | Thickness (μ) | Crystallnity (%) | J/m | Index | (g/cm) | Appearance | (g/cm) | Appearance |
| Ex. 1 | 25 | 45 | 18000 | 33 | smaller than 0.1 | good | smaller than 0.1 | good |
| Ex. 2 | 15 | 53 | 15000 | 32 | smaller than 0.1 | good | smaller than 0.1 | good |
| Ex. 3 | 35 | 60 | 13000 | 33 | smaller than 0.1 | good | smaller than 0.1 | good |
| Ex. 4 | 30/100 | 53 | 12500 | 33 | smaller than 0 1 | good | smaller than 0 1 | good |
| Ex. 5 | 50/150 | 48 | 13000 | 33 | smaller than 0 1 | good | smaller than 0 1 | good |
| Ex. 6 | 30 | 35 | 3000 | 31 | smaller than 0.1 | good | smaller than 0.1 | good |
| Ex. 7 | 50 | 51 | 15000 | 33 | smaller than 0.1 | good | smaller than 0.1 | good |
| Ex. 8 | 25 | 53 | 35000 | 32 | smaller than 0.1 | good | smaller than 0.1 | good |
| Comp. Ex. 1 | 35 | — | — | 24 | 7.9 | much adhered, | 2.1 | much adhered, |
| | | | | | | yellowed | | yellowed |
| Comp Ex. 2 | 25 | 25 | 18000 | 33 | 15.5 | adhered | 7.5 | adhered |
| Comp Ex. 3 | 25 | 53 | 350 | 32 | smaller than 0.1 | cracked | smaller than 0.1 | cracked |
| Comp Ex. 4 | 25 | 45 | 18000 | 48 | 5.5 | adhered | 0.3 | adhered |

### EXAMPLES 2 AND 3

Films were produced in the same manner as in Example 1, except that the components constituting the SPS resin composition and the film thickness were varied as in Table 1. The data of those films are in Table 1.

### EXAMPLE 4

A two-layered laminate film was produced in the same manner as in Example 1, except that the SPS resin composition indicated in Table 1 was co-extruded with poly(4-methylpentene-1), MX0002 (from Mitsui Chemical). The data of the laminate film are in Table 1.

### EXAMPLE 5

A film was produced from the SPS resin composition indicated in Table 1, in the same manner as in Example 1. This was laminated with a polypropylene sheet, Taiko FC,SS (from Nimura Chemical) using a hot-melt adhesive, Rexpearl 182M (from Nippon Polyolefin). The data of the laminate film are in Table 1.

### EXAMPLES 6 AND 7

The SPS resin composition indicated in Table 1 was formed into a film through inflation molding, for which used was a 50 mmφ single-screw (dulmage type screw) extruder equipped with a 50 mmφ disc die having a gap of 1 mm. The melt extrusion rate was 20 kg/hr at 300° C., the blow ratio was 2.5 and the draw ratio was 13. During the inflation molding, the extruder was aerated, and a heat-insulating material was fitted to the stabilizer plate so as to stabilize the bubbles in aeration. The data of the film are in Table 1.

### EXAMPLE 8

The SPS resin composition indicated in Table 1 was formed into a sheet having a thickness of 250 μm through melt extrusion at 300° C. using a 50 mmφ single-screw (full-flight type screw) extruder equipped with a 500 mm-wide coat hanger die, for which the extrusion rate was 50 kg/hr. The sheet was stretched 2.9-fold in the machine direction at 110° C. and 3.1-fold in the transverse direction at 120° C., and then subjected to heat treatment at 230° C. for 5% relaxation for 10 seconds to be a biaxially-oriented film. The data of the film are in Table 1.

### COMPARATIVE EXAMPLE 1

A commercially-available polymethylpentene film, X-66 (from Mitsui Chemical) was tested for its high-temperature peelability. The data of the film are in Table 1.

### COMPARATIVE EXAMPLE 2

The same process as in Example 1 was repeated, except that the cast film was not subjected to heat treatment. The data of the film are in Table 1. The degree of crystallinity of the film was low.

### COMPARATIVE EXAMPLE 3

The same SPS resin composition as in Example 8 was formed into a cast film in the same manner as in Example 1. In this, the film was not biaxially oriented, being different from that in Example 8. The data of the film obtained herein are in Table 1. The film impact was low.

### COMPARATIVE EXAMPLE 4

The crystalline film as produced in Example 1 was subjected to corona treatment. The data of the thus-treated film are in Table 1. The wettability index of the film was high.

As described in detail hereinabove, the lubricant film of the invention has the advantages of high-temperature lubricity, environmental adaptation and workability.

While the invention has been described in detail and with reference to specific embodiments thereof, it will be apparent to one skilled in the art that various changes and modifications can be made therein without departing from the spirit and scope thereof.

What is claimed is:

1. A lubricant film of which at least the surface layer is of a styrenic polymer essentially having a syndiotactic structure or of a resin composition that comprises a styrenic polymer essentially having a syndiotactic structure, wherein said layer has a degree of crystallinity of at least 30%, a film impact of at least 2000 J/m and a wettability index of at most 36.

2. The lubricant film as claimed in claim 1, wherein the resin composition that comprises a styrenic polymer essentially having a syndiotactic structure comprises from 50% up to but not including 100% by weight of a styrenic polymer essentially having a syndiotactic structure and from greater than 0% to 50% by weight of a rubber-like elastomer.

3. The lubricant film as claimed in claim 1 or 2, which is for process films.

4. The lubricant film as claimed in claim 3, which is used in producing laminate sheets, in producing flexible printed circuit board substrates, in producing high-tech composite materials, or in producing sports and leisure goods.
